(19) United States
(12) Patent Application Publication
(10) Pub. No.: US 2015/0122415 A1
(43) Pub. Date: May 7, 2015

(54) COMPOSITE BAT WITH VARYING BARREL THICKNESSES

(71) Applicant: Thu Van Nguyen, West Hills, CA (US)

(72) Inventor: Thu Van Nguyen, West Hills, CA (US)

(21) Appl. No.: 14/596,773

(22) Filed: Jan. 14, 2015

Related U.S. Application Data
(62) Division of application No. 13/612,197, filed on Sep. 12, 2012.

(51) Int. Cl. B32B 37/02; A63B 59/06; B32B 37/18; B32B 38/00; B32B 37/12; B32B 37/14

(52) U.S. Cl. CPC B32B 37/02; B32B 37/1284; B32B 37/144; B32B 37/18; B32B 38/00; A63B 59/06; B32B 2038/0076; B32B 2305/076; B32B 2305/22; B32B 2307/558; B32B 2311/24; B32B 2313/04; B32B 2315/08; B32B 2597/00; A63B 2059/065
USPC 156/294

(57) ABSTRACT

A baseball or softball bat includes a composite bat body having a handle and a barrel extending from the handle. The bat body is of a variable thickness along a length thereof. A generally tubular, resilient sleeve is disposed adjacent to an exterior of the barrel intermediate ends of the bat body. The bat body and sleeve are interconnected with one another such that the sleeve and bat body provide a generally continuous exterior surface of the bat.

### BACKGROUND OF THE INVENTION

The present invention generally relates to baseball and softball bats. More particularly, the present invention relates to a bat having a composite bat body of variable thickness and a sleeve.

Baseball and softball are very popular sports in the United States and many other countries. Due to the competitive nature of these sports, players are constantly seeking ways of improving their performance. An important aspect of baseball and softball is the ability to effectively hit the ball.

Metal (aluminum) bats are allowed in baseball amateur play from Little League to College levels. Metal bats are also typically used in slow and fast pitch softball. Metal bats are advantageous over wood bats in that they do not break and splinter like wood bats and thus can be used repeatedly with consequent cost savings.

However, metal bats have certain disadvantages, including vibrating upon impact and sending painful vibrations into the hands and arms of the batter if the ball is not hit within the “sweet spot” of the bat. Metal bats, particularly aluminum bats, may also dent or otherwise deform due to forceful impacts with the ball. Metal bats also emit an undesirable high-pitched metallic sound, as opposed to the traditional sound heard when a wood bat contacts the ball.

Various attempts have been made to overcome the problems associated with metal bats, including coating or wrapping the exterior of the metal bat with material such as carbon reinforcing fibers to enhance batting performance. Other attempts have been made to insert internal layers or compartments within the metal bat to improve performance. Bats that incorporate composite materials tend to be much lighter than metal bats. However, while providing benefits, these designs also have drawbacks in that they can be expensive to manufacture and are prone to structural failure.

Notwithstanding the disadvantages of metal and composite bats, these bats are very popular at the amateur level as not only can they be used repeatedly with consequent cost savings, but they also have a larger “sweet spot” hitting area or power zone than wood bats. Furthermore, the ball comes off a metal bat faster than a wood bat, resulting in longer hits.

In fact, over the years there have been many injuries and near misses attributed to the speed from which the ball comes off a metal and/or composite bat. Several years ago the National Collegiate Athletic Association (NCAA) for college baseball and the National Federation of High School Association (NFHS) for high school baseball began to regulate the batted-ball speeds of baseball bats indirectly by regulating the Ball Exit Speed Ratio (BESR) and controlling the bat swing speed by limiting the moment-of-inertia (MOI) of non-wood baseball bats. This complicated standard measured the ratio of the ball exit speed to the combined speeds of the pitched ball and the swung bat.

More recently, a new standard was set forth by the NCAA and NFHS which measures bat performance and replaces the previous BESR standard. This new standard is referred to as the BBCOR Bat Standard, or the Batted-Ball Coefficient of Restitution, sometimes referred to as Bat-Ball Coefficient of Restitution. Instead of measuring the speed of the ball after it is batted, BBCOR measures the “bounciness” of the ball and bat or the “trampoline” effect. A pitched ball holds a lot of energy, and with solid wood bats much of that energy is lost as the ball compresses on impact. With hollow metal and composite bats, the ball distorts less, retaining its pitched energy, and adds to it the power of the bat speed. Hence, traditionally non-wood bats have hit balls faster. BBCOR is calculated using the inbound and rebound speeds of the ball. The loss of energy at impact is what BBCOR measures, and the new standard ensures that performances by non-wood bats are more comparable to those of wood bats.

Currently, BBCOR is calculated using the following equation:

$$BBCOR = \frac{{v}_{R}}{{v}_{I}} ( 1 + r ) + r + {C}_{ball}$$

where v_{I} and v_{R} are the ball inbound and rebound speeds respectively, r is calculated using the equation below, and C_{ball} is the measured correction factor for each baseball bat, including length, weight, pivot location and balance point, according to the following equation:

$$r = m [ \frac{1}{W} + \frac{{( L - BP - z )}^{2}}{I - {W ( BP - 6 )}^{2}} ]$$

In order to meet the standard, the BBCOR must be less than or equal to 0.500. The NCAA began requiring BBCOR approved bats in 2011. The NFHS required BBCOR certified bats for the 2012 season and beyond.

Accordingly, there is a need for a bat which both provides the advantages of metal and composite bats over wood bats, while meeting the BBCOR standard. The present invention fulfills these needs and provides other related advantages.

### SUMMARY OF THE INVENTION

The present invention resides in a baseball or softball bat which has a varying barrel thickness and a sleeve placed over at least a portion of the barrel so as to meet requirements relating to BBCOR, typically referred to as Batted-Ball Coefficient of Restitution or Bat-Ball Coefficient of Restitution.

The baseball or softball bat generally comprises a composite bat body including a handle and a barrel extending from the handle. The bat body is of a variable thickness along a length thereof. Preferably, at least a portion of the barrel of the bat body is thinner than the handle and end of the barrel.

The composite body is comprised of a plurality of layers of composite material or laminate layers. At least a portion of the barrel comprises fewer layers of composite material than the handle and end of the barrel. Typically, the portion of the barrel is comprised of twenty or fewer layers of composite material, and may be comprised of five or fewer layers of composite material, or even a single layer or two of composite material. The handle and the end of the barrel are typically comprised of more layers than that of the thinner portion of the barrel. However, the handle and ends of the barrel may be comprised of up to forty layers of composite material.

A generally tubular, resilient sleeve is disposed adjacent to an exterior of the barrel intermediate the ends of the bat body. The sleeve is comprised of metal or composite material having greater impact absorption and resistance characteristics than the composite bat body. The sleeve is typically disposed over the thinner portion of the barrel and defines a ball striking portion of the bat. The ball striking portion of the bat has a predetermined BBCOR.

Means are provided for interconnecting the bat body and sleeve in a coaxial relation wherein a portion of the bat body overlaps the sleeve. The interconnecting means may include an annular recess disposed at an end of the barrel of the bat body, for receiving an end of this sleeve therein. The end of the sleeve is tapered for engagement with the annular recess. In any case, the interconnection of the sleeve and the bat body provides a generally continuous exterior surface of the bat.

Other features and advantages of the present invention will become apparent from the following more detailed description, taken in conjunction with the accompanying drawings, which illustrate, by way of example, the principles of the invention.

### BRIEF DESCRIPTION OF THE DRAWINGS

The accompanying drawings illustrate the invention. In such drawings:

FIG. 1 is a side elevational view of a bat embodying the present invention;

FIG. 2 is a cross-sectional view of a bat embodying the present invention;

FIG. 3 is a cross-sectional view taken generally along line 3-3 of FIG. 1;

FIG. 4 is a cross-sectional view taken generally along line 4-4 of FIG. 1;

FIG. 5 is a cross-sectional view taken generally along line 5-5 of FIG. 1;

FIG. 6 is an enlarged cross-sectional view of area “6” of FIG. 2;

FIG. 7 is an enlarged cross-sectional view illustrating the interconnection of a sleeve to an end of the bat body, in accordance with the present invention;

FIG. 8 is a cross-sectional and exploded view illustrating the sleeve being brought over the bat body, in accordance with the present invention;

FIG. 9 is a cross-sectional view, illustrating the interconnection of a lower end of the sleeve with the bat body;

FIGS. 10A and 10B are flow charts depicting the steps taken in accordance with the present invention in creating the sleeve of the bat; and

FIGS. 11A and 11B are flow charts depicting the steps of creating the composite bat body and the finished bat, in accordance with the present invention.

### DETAILED DESCRIPTION OF THE PREFERRED EMBODIMENTS

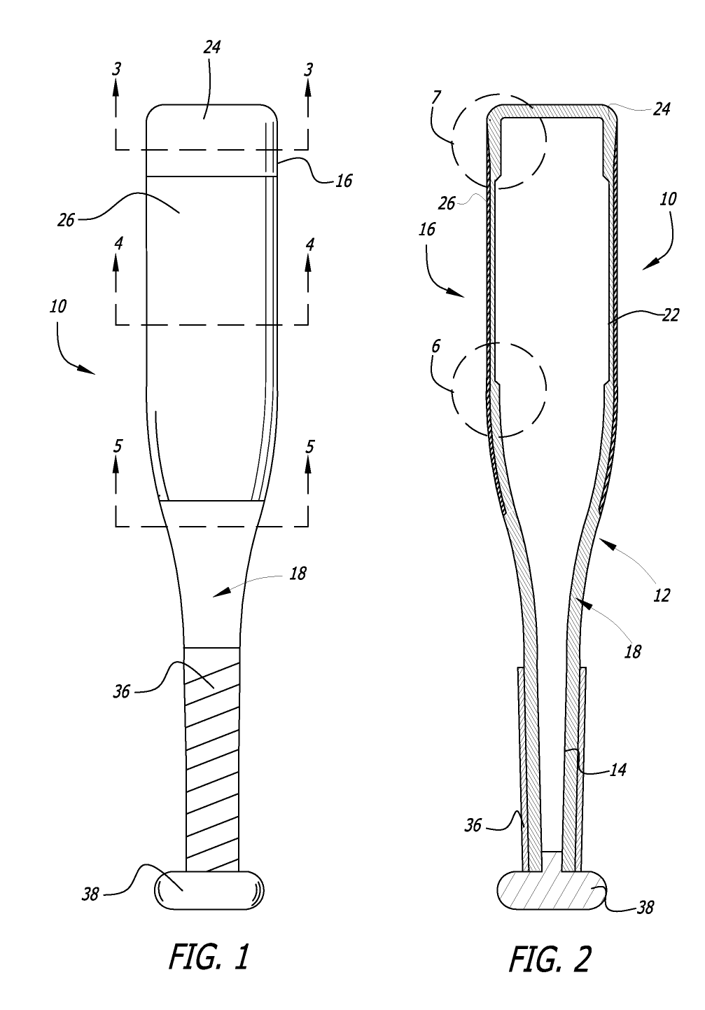

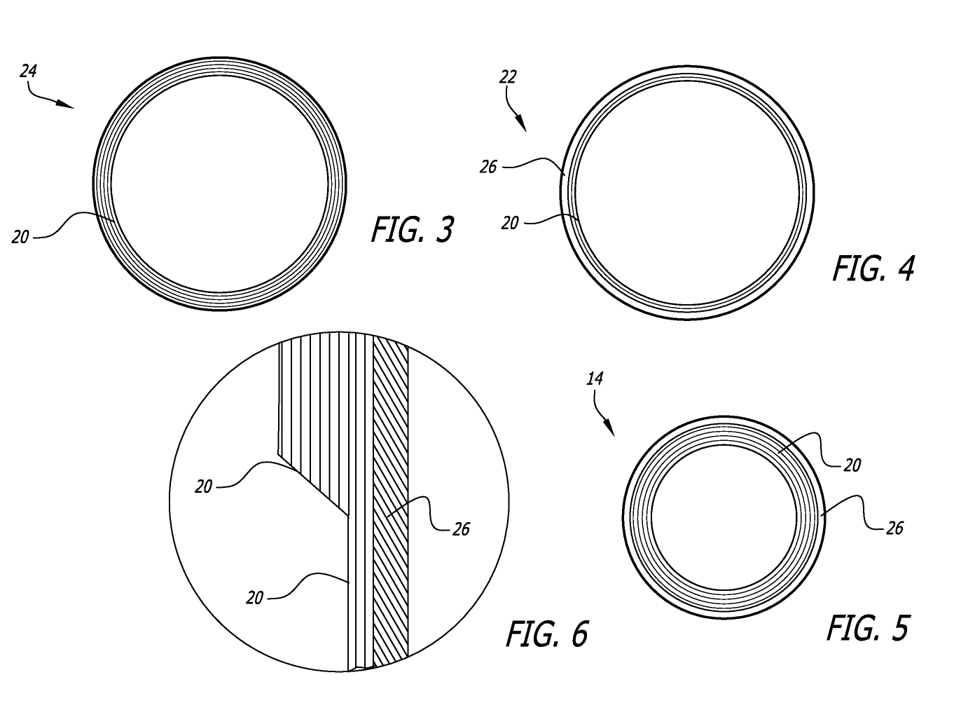

As shown in the accompanying drawings, for purposes of illustration, the present invention is concerned with a bat 10 for use in baseball or softball. With reference now to FIGS. 1 and 2, the bat 10 comprises a composite bat body 12 which includes a handle portion 14 at one end thereof and a barrel portion 16 at a generally opposite end thereof. The handle 14 and barrel 16 portions are integrally connected to one another, such that the barrel portion 16 extends from the handle 14. Typically, as illustrated, the handle portion 14 is of a much smaller diameter than the barrel portion 16, and thus there can be considered to be a generally tapered portion 18 intermediate the handle 14 and barrel 16 portions.

The bat body 12 is preferably made from a composite material, e.g., fiberglass, carbon fibers, or a combination of glass and carbon fibers. For example, 80% glass to 20% carbon will make a very flexible bat, whereas 20% glass to 80% carbon makes a very stiff bat, or any other ratio of glass to fiber in order to obtain a desired flex in the bat 10.

The bat body 12 is comprised of a number of laminate layers. An aspect of the present invention is that the number of laminate layers, and thus the thickness, of the bat body along a length thereof varies. This is illustrated in FIGS. 1-5. With reference to FIG. 3, towards an end of the barrel section 16 there are a number of laminate layers 20 of the composite material. However, as illustrated in FIG. 4, there are fewer laminate layers 20 of the composite material in a mid-section of the barrel 16 so as to create a thinner portion of the barrel which defines a ball striking portion of the bat 10. With reference now to FIG. 5, it can be seen that the handle portion 14 also has a large number of laminate layers 20.

It will be appreciated that the number of laminate layers 20 along the length of the bat body can be varied as needed to meet the desired characteristics of the bat. For example, with reference to FIGS. 3 and 5, the end of the barrel 16 and the handle portion 14 may have up to forty laminate layers of the composite material 20. The ball striking portion 22 of the bat body, intermediate the end of the bat barrel 16 and the handle portion 14 can have up to twenty layers of laminate material 20. Typically, the ball striking portion 22 of the bat 10 will have fewer laminate layers 20 than that of the end of the barrel 16 and the handle 14 (or even the tapered section 18) of the bat body 12. However, the number of laminate layers of composite material can be selected and created during the manufacturing of the bat 10 to meet the desired characteristics of the bat 10. Thus, while the handle portion 14 is illustrated in FIG. 5 as having more laminate layers 20 than the end of the barrel 16 illustrated in FIG. 3, this is not necessarily the case. These sections 14 and 16 can have as few as a single laminate layer or more, typically up to forty layers of laminate composite material. However, in a particularly preferred embodiment, at least a portion of the barrel comprises fewer layers of the composite material 20 than the handle 14 and the end 24 of the barrel. In fact, the ball striking portion 22 of the barrel 16 may be comprised of five or fewer layers of the composite material, and in some instances only one or two layers of the composite material, as illustrated in FIG. 4.

With reference again to FIGS. 1 and 2, the bat 10 also includes a generally tubular, hollow, resilient sleeve 26 which is disposed adjacent to an exterior of the barrel 16 intermediate ends of the bat body 12. The sleeve 26 is comprised of a metal or composite material which has greater impact absorption and resistance characteristics than the composite bat body 12. For example, the sleeve 26 may be comprised of a lightweight yet durable metal, such as aluminum, titanium, magnesium, or alloy thereof which has a different impact absorption and resistance than the material forming the bat body 12. The sleeve 26 may be formed of an aluminum alloy or even a composite material, including fiberglass, carbon fibers, or a combination of glass and carbon fibers so long as the sleeve 26 has a greater impact absorption and resistance characteristics than the composite material forming the bat body 12. Typically, the sleeve is comprised of a 6,000 or 7,000 series of aluminum alloy in which zinc is the major alloying element coupled with a smaller percentage of magnesium, resulting in a heat-treatable alloy of very high strength.

With reference now to FIGS. 2, 4 and 6, the sleeve 26 is disposed over at least a portion of the barrel 16 of the bat body 12, including the thinner ball striking portion 22 of the barrel 16. The sleeve 26 can be of varying lengths so as to extend substantially only over the ball striking portion 22 of the barrel 16, extend towards the uppermost end of the end 24 of the barrel 16, and/or a lower portion and even onto the tapered portion 18 of the barrel 16.

FIG. 1 illustrates a sleeve 26 which is shorter than the sleeve illustrated in FIG. 2. In FIG. 1, with the sleeve being shorter, the end portion 24 of the barrel 16 which remains exposed is longer than that of FIG. 2. For example, the exposed end portion 24 of FIG. 1 may be two inches to three inches in length, whereas the exposed portion in FIG. 2 may only be one-half of an inch. This will also give the bat different characteristics, including the bat of FIG. 1 being of a lighter weight than that of FIG. 2 due to the smaller sleeve and thus a lighter weight.

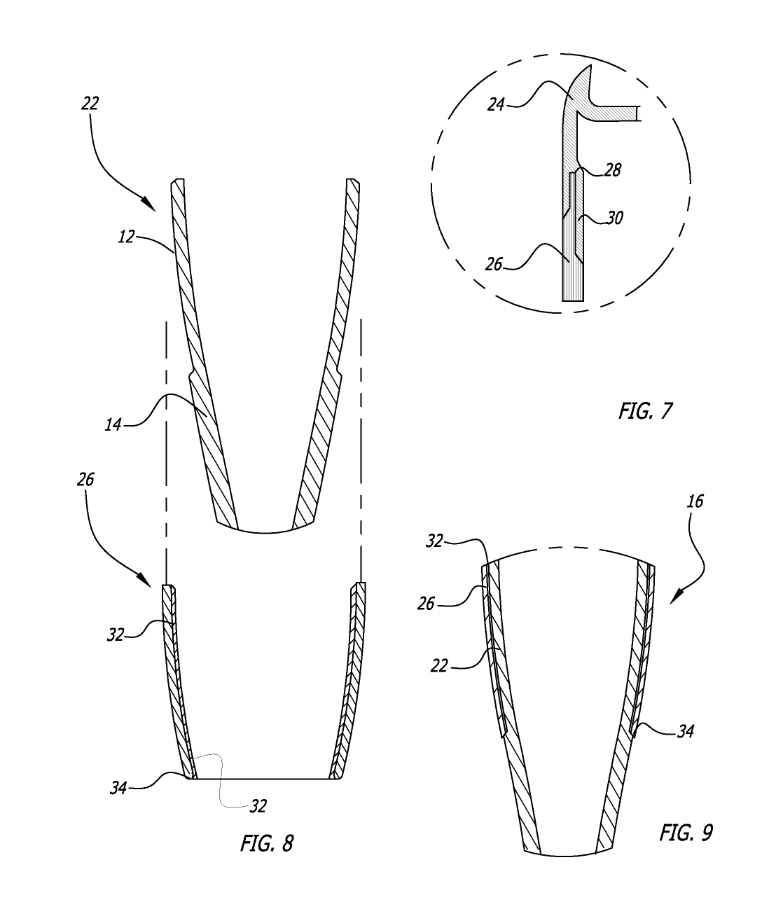

The sleeve 26 and bat body 12 are interconnected so as to provide a generally continuous exterior surface of the bat 10. With reference to FIG. 7, means are provided for interconnecting the bat body 12 and sleeve 26 in a coaxial relation, wherein a portion of the bat body 12 overlaps the sleeve 26. Such means includes an annular recess 28 disposed at an end 24 of the barrel 16 of the bat body 12 for receiving an end of the sleeve 26 therein. Typically, the end 30 of the sleeve 26 is tapered for engagement with and insertion into the annular recess 28. Thus, the end 30 of the sleeve 26 curls or tapers inwardly for engagement with the annular recess 28 of the barrel 16.

The barrel 16 of the bat body 12 has a maximum exterior diameter surface which is generally equal to a maximum exterior diameter surface of the sleeve 26 for providing a generally continuous exterior surface of the bat 10 when the sleeve 26 engages the barrel 16 of the bat body 12. The barrel 16 of the bat body 12 also includes a minimum exterior diameter surface generally equal to a minimum interior diameter surface of the sleeve 26 for providing friction-fit engagement of the sleeve 26 and the barrel 16 of the bat body 12.

With reference now to FIGS. 8 and 9, a portion of the bat body 12, and more particularly the barrel 16 portion is shown, including the thinner ball striking portion 22 as well as a portion of the tapered section 14. The sleeve 26 is sized so as to be extended over the handle and onto the barrel 16 of the bat body 12, as shown. Typically a bonding agent 32 is applied to the inner surface of the sleeve 26 so as to bond the sleeve 26 and the bat body 12 to one another when properly positioned. It will be seen in FIGS. 8 and 9 that the lower end 34 of the sleeve 26 is tapered to match the taper of the barrel 16. The end 34 is rounded and tapers inwardly so as to provide a generally continuous taper between the exterior surface of the tapered section 14 and the barrel 16, as illustrated in FIG. 9.

It will be appreciated that not only can the length of the sleeve 26 vary, but also other aspects of the bat 10. For example, the length of the intermediate tapered section 18 and the entire bat body 12 will be varied based upon the size and type of bat, such as taking into account adult baseball bats, youth baseball bats, softball bats, etc.

With reference again to FIGS. 1 and 2, the bat 10 also typically includes a grip 36 extending over at least a portion of the handle 14 section of the bat body 12 so as to provide cushion and a gripping surface for the user. The wrapped grip 36 can be comprised of rubber, polyurethane, leather or the like.

A knob 38 is securely attached to an end of the handle 14, by a variety of means, including, without limitation, bonding agents, glues, adhesives, or the like. The knob 38 may be made of various materials including, without limitation, aluminum, polyurethane, polycarbonate, a composite material, Zytel, Delrin, plastic or the like.

Although the bat 10 may also include an end plug or cap disposed at an end 24 of the barrel 16 of the bat body 12 (not illustrated) more often the “cap” is formed of a composite material of a single piece construction with the barrel 16 of the bat body 12 which is simply molded or otherwise formed into the end cap of the barrel 16.

The combination of the sleeve 26 and the bat body 12 at the ball striking portion 22 is such so as to meet the BBCOR standard or requirement. The type of material used for the sleeve, the thickness of the sleeve, the type and thickness of the bonding agent disposed between the sleeve 26 and the bat body 12, as well as the thickness or number of laminate composite layers of the ball striking portion 22 of the barrel 16 can all be adjusted as needed in order that the bat meet the BBCOR requirement, currently 0.500 or less. Incorporation of the typically metal sleeve 26 enables the ball striking portion 22 of the barrel 16 to be thinner and use fewer laminate composite layers than the ends of the barrel 16 and the handle and taper portions 14 and 18 of the bat body 12. This enables the designers of the bat 10 to still create a bat that meets the BBCOR requirement while manufacturing a relatively lightweight bat, which is preferred.

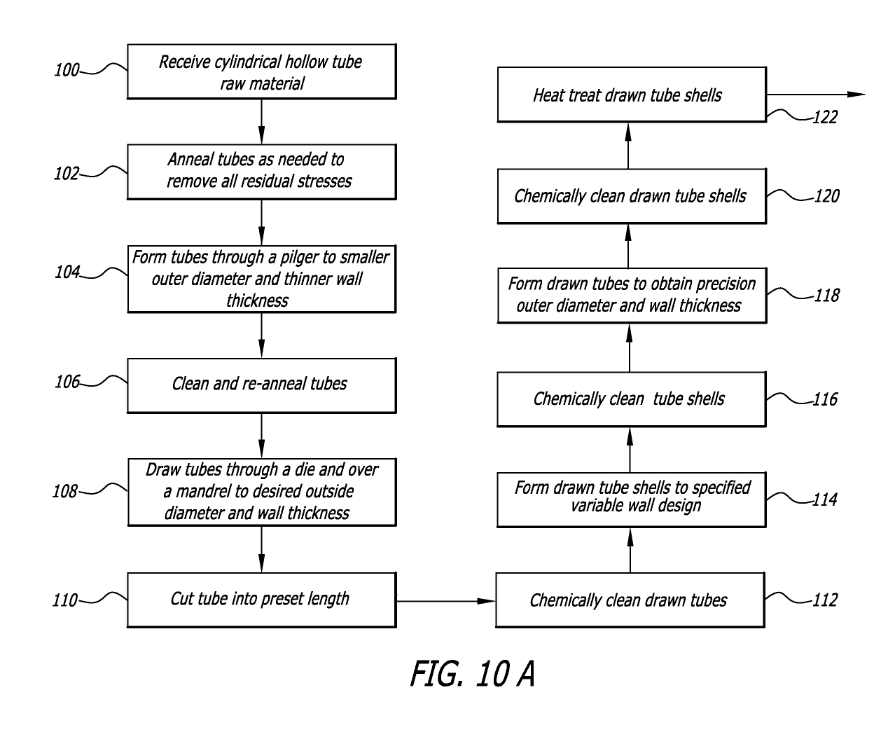

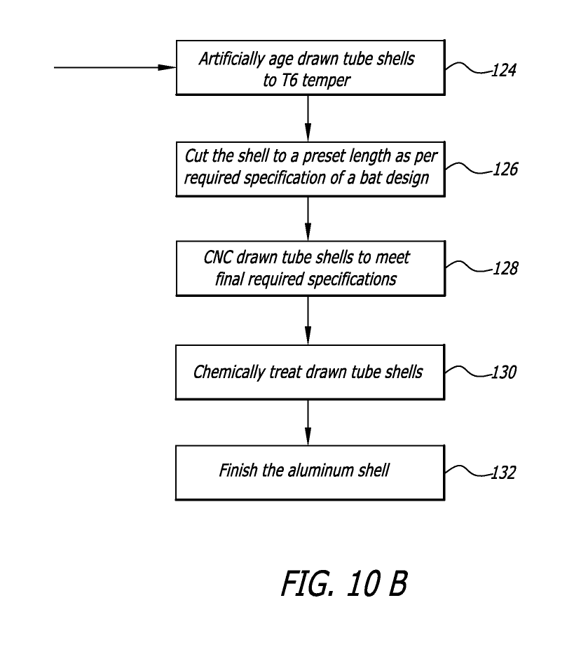

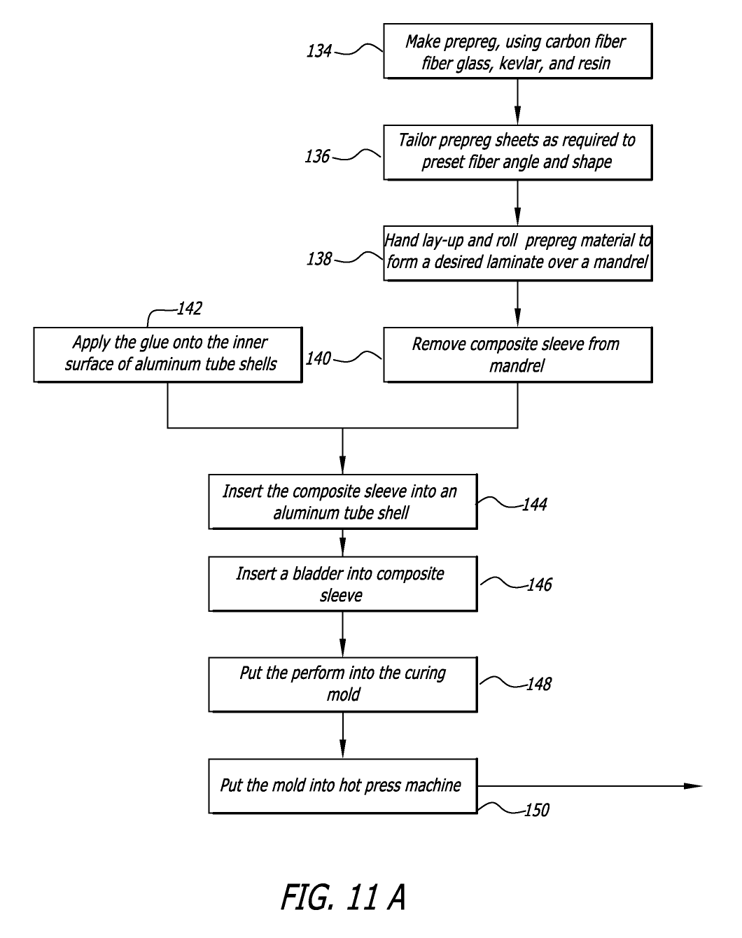

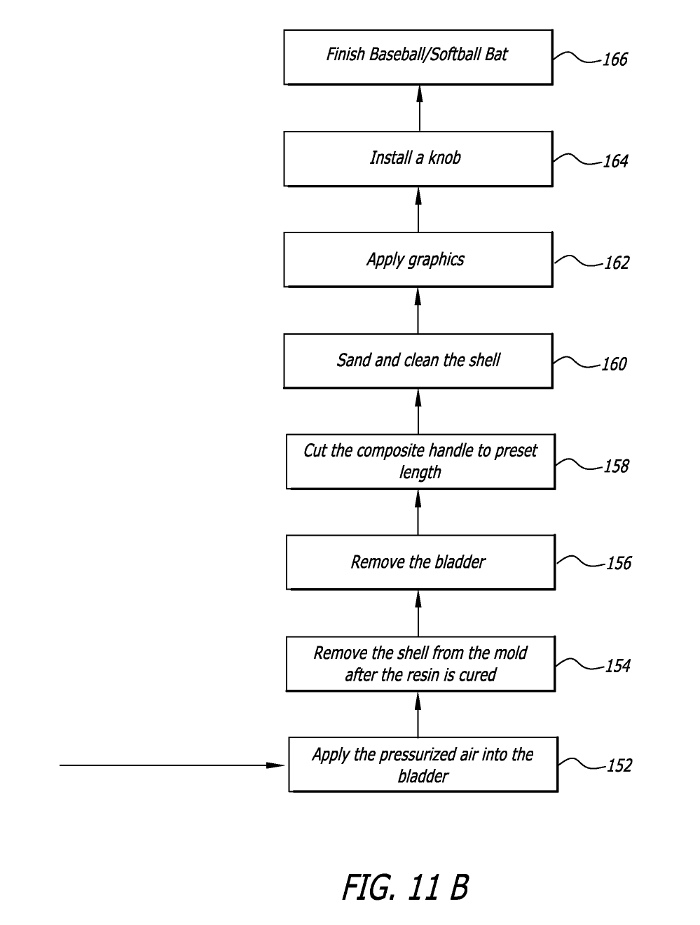

With reference now to FIGS. 10 and 11, the steps taken in accordance with manufacturing a bat 10 embodying the present invention are shown. More particularly, FIGS. 10A and 10B illustrate the steps taken in creating the sleeve 26 of the bat 10, while FIGS. 11A and 11B illustrate the steps taken in the creation of the bat body 12 and the finished bat 10. The bat 10 may be manufactured and assembled in a number of ways, and it is to be understood that the following methods may be altered in some respects while still creating a bat 10 having the desired characteristics. Also, certain dimensions, materials, temperatures, etc. may be altered depending upon the size, weight and intended use of the resulting bat 10 such as for baseball, softball, etc.

With reference now to FIG. 10, cylindrical hollow tubes of the raw material are received (100). These are typically cylindrical hollow tubes of metal in annealed or fabricated condition. The tubes are annealed as needed to remove residual stresses (102). The tubes are then formed through a pilger to smaller outer diameter and thinner wall thicknesses (104), depending upon the desired characteristics of the bat. The tubes are then cleaned and re-annealed (106). The tubes are then drawn through a die and over a mandrel to a desired outer diameter and wall thickness (108). The tubes are then cut into a preset length (110).

The drawn tubes are then chemically cleaned (112) and the drawn tubes are formed into shells to specified variable wall design (114). A series of draws may be used to form variable wall thickness in a rough condition as required by the design. The tube shells are then chemically cleaned again (116) and the drawn tubes are formed to obtain precision outer diameter and wall thickness (118). This is a final draw to form precise variable wall thickness as per the required design.

The drawn tube shells are chemically cleaned again (120), and heat treated (122). The drawn tube shells are artificially aged to a desired temper, such as T6 temper (124).

The shell is cut to a preset length as per required specification of the bat design (126), and the drawn tube shells are passed through a CNC process to meet final required specifications (128). The barrel end 16 of the bat shell 12 is machined to specified specifications of a bat design to create a smooth transition between aluminum and the laminate inner shell. The drawn tube shells are then chemically treated again (130) and finished (132).

With reference now to FIG. 11, pre-preg (pre-impregnated composite fibers or sheets) are made using carbon fiber, fiberglass, Kevlar, resin, etc. (134) as needed, or obtained from outside sources. The pre-preg sheets are tailored as required to preset fiber angle and shape (136). This typically involves cutting the pre-preg material into predetermined shapes and angles as required by the given bat design.

The pre-preg material is hand laid and rolled to form a desired laminate over a mandrel (138). That is, the pre-preg sheets from steps 134, 136 are laid up and rolled onto a mandrel to build a laminate. The number of layers will vary from location to location on the mandrel as per the specified features of the bat design. The number of sheets for the handle portion 14, taper 18, and end barrel 24 sections can be up to forty layers. The number of sheets for the barrel section, and particularly the ball striking portion 22 of the barrel 16 is typically fewer and can be up to twenty layers. However, as described above, the number of layers can vary across the length of the bat and body 12 such that the number of sheets for the handle, taper and barrel end sections can be from one to forty layers, and the number of sheets for the barrel section can be from one to twenty layers. The resulting composite sleeve is then removed from the mandrel (140).

Glue is applied to the inner surface of the aluminum tube shells forming the sleeves (142), and the composite sleeve or bat body is inserted into an aluminum tube shell sleeve (144). A bladder is inserted into the composite sleeve or bat body (146). The preform consisting of the aluminum tube shell/sleeve 26 and the bat body 12 is put into a curing mold (148). The mold is put into a hot press machine (150) and pressurized air is applied into the bladder (152).

After the resin is cured, the shell is removed from the mold (154), and the bladder is removed (156). The composite handle is cut to a preset length (158). The shell (combined sleeve 26 and bat body 12) is sanded and cleaned (160). Graphics are applied (162) as desired. The graphics and decorations may include paint, chrome, powder-coating, or other methods of decorative coating and/or labels and the like. The graphics may be created by heat transferring, pad stamping, silk screening, etc. The knob 38 is installed (164) and the baseball or softball bat is finished (166). As discussed above, although a separate end cap could be incorporated into the bat, more typically the end 24 of the barrel 16 is molded into a closed end of the bat 10, as shown in the accompanying illustrations.

Although several embodiments have been described in detail for purposes of illustration, various modifications may be made without departing from the scope and spirit of the invention. Accordingly, the invention is not to be limited, except as by the appended claims.

1.-26. (canceled)

27. A method for creating a baseball or softball bat, comprising the steps of:
providing a plurality of composite fibers or sheets;
layering the composite fibers or sheets to create a laminate composite bat body comprising a barrel having a first end at one end thereof and a tapered section at a generally opposite second end thereof and a ball striking portion intermediate the first end and the tapered section, wherein the number of layers of composite fibers or sheets is varied along the length of the barrel such that the ball striking portion has fewer layers of composite fibers or sheets than the first end and the tapered section of the barrel; and
placing a metal sleeve over at least a portion of the ball striking portion of the barrel.

28. The method of claim 27 wherein the layering step comprises layering up to twenty layers of composite fiber sheets at the ball striking portion.

29. The method of claim 28, wherein the layering step comprises layering up to forty layers of composite fiber sheets at the first end and tapered section of the barrel.

30. The method of claim 27, wherein the providing step comprises providing pre-impregnated composite fibers or sheets.

31. The method of claim 27, wherein the composite fibers or sheets are layered on a mandrel to create the laminate composite bat body.

32. The method of claim 27, including the step of curing the bat body and sleeve.

33. The method of claim 27, wherein the metal sleeve is selected having greater impact absorption and resistance characteristics than the composite bat body.

34. The method of claim 27, including the step of applying adhesive between the metal sleeve and the barrel.

35. The method of claim 27, wherein the number of layers of composite fibers or sheets at the ball striking portion and the metal sleeve are selected to create a bat having a BBCOR of 0.500 or less.

36. The method of claim 27, including layering the composite fibers or sheets to create a handle section of the bat body having more laminate composite fibers or sheet layers than the ball striking portion.

37. The method of claim 36, wherein the layering step of the handle section comprises layering up to forty layers of composite fibers or sheets.

38. The method of claim 36, including the step of attaching a knob to an end of the handle section.

39. The method of claim 27, including the step of attaching an end cap to the first end of the barrel section or molding closed the first end of the barrel section.

40. A method for creating a baseball or softball bat, comprising the steps of:
providing a plurality of composite fibers or sheets;
layering the composite fibers or sheets to create a laminate composite bat body comprising a barrel having a first end at one end thereof and a tapered section at a generally opposite second end thereof and a ball striking portion intermediate the first end and the tapered section, wherein the number of layers of composite fibers or sheets is varied along the length of the barrel such that the ball striking portion has fewer layers of composite fibers or sheets than the first end and the tapered section of the barrel, wherein up to twenty layers of composite fiber sheets are layered at the ball striking portion and up to forty layers of composite fiber sheets layered at the first end and tapered section of the barrel; and
placing a metal sleeve, having greater impact absorption and resistance characteristics than the composite bat body, over at least a portion of the barrel, including the ball striking portion;

41. The method of claim 40, wherein the providing step comprises providing pre-impregnated composite fibers or sheets.

42. The method of claim 40, wherein the composite fibers or sheets are layered on a mandrel to create the laminate composite bat body.

43. The method of claim 40, including the step of curing the bat body and sleeve.

44. The method of claim 40, including the step of applying adhesive between the metal sleeve and the barrel.

45. The method of claim 40, wherein the number of layers of composite fibers or sheets at the ball striking portion and the metal sleeve are selected to create a bat having a BBCOR of 0.500 or less.

46. The method of claim 40, including layering the composite fibers or sheets to create a handle section of the bat body having more laminate composite fibers or sheet layers than the ball striking portion, wherein the layering step of the handle section comprises layering up to forty layers of composite fibers or sheets.

47. The method of claim 46, including the step of attaching a knob to an end of the handle section.

48. The method of claim 40, including the step of attaching an end cap to the first end of the barrel section or molding closed the first end of the barrel section.
